(19) United States
(12) Patent Application Publication
(10) Pub. No.: US 2016/0054848 A1
(43) Pub. Date: Feb. 25, 2016

(54) DISPLAY CONTROLLING DEVICE AND ELECTRONIC APPARATUS

(71) Applicant: KYOCERA Document Solutions Inc., Osaka (JP)

(72) Inventor: Koji MAEDA, Osaka-shi (JP)

(73) Assignee: KYOCERA Document Solutions Inc., Osaka (JP)

(21) Appl. No.: 14/818,679

(22) Filed: Aug. 5, 2015

(30) Foreign Application Priority Data
Aug. 19, 2014 (JP) 2014-166878

(51) Int. Cl. G06F 3/041; H04N 1/00; G06F 3/0488

(52) U.S. Cl. CPC G06F 3/0416; G06F 3/04886; H04N 1/00392; G06F 2203/04805

(57) ABSTRACT

A display controlling device includes a display part, a distance detecting part, a coordinate detecting part and a magnifying and displaying part. The display part has a display area displaying images. The distance detecting part detects a space distance between an indication body used for indicating the image displayed on the display area and the display area. The coordinate detecting part detects coordinates on the display area corresponding to a position of the indication body when the space distance is equal or less than a first threshold value. The magnifying and displaying part, when detected coordinates are not varied for a limit time or more, executes magnifying and displaying process magnifying a periphery image displayed on a periphery area including the detected coordinates on the display area by a magnification ratio to create a periphery magnification image and displaying and superimposing the periphery magnification image on the periphery image.

### INCORPORATION BY REFERENCE

This application is based on and claims the benefit of priority from Japanese Patent application No. 2014-166878 filed on Aug. 19, 2014, the entire contents of which are incorporated herein by reference.

### BACKGROUND

The present disclosure relates to a display controlling device and an electronic apparatus including the controlling device, particularly, a technique magnifying and displaying an image.

Conventionally, with regard to an electronic apparatus including a display part having a touch panel function, a technique changing a display state of the display part in accordance with a distance between an indication body, such as a finger or a pen, used for touch operation and the display part.

For example, a technique, in a case where the finger is brought close to a touch panel on which a plurality of images (e.g. icons and keys) are displayed, detecting coordinates corresponding to a position of the finger on the touch panel and magnifying and displaying an image displayed at the position of the detected coordinates is known.

However, in the above-mentioned technique, because only image to which the indication body is brought close is magnified and displayed, there is a possibility that it is difficult to visually recognize the image around the image to which the indication body is brought close. Therefore, when a user finds a desired image from the plurality of displayed images, the user must take labor bringing the indication body close to each of the images to make magnify and display each image and recognizing the images one by one whether or not each magnified and displayed image is the desired image.

### SUMMARY

In accordance with the present disclosure, a display controlling device includes a display part, a distance detecting part, a coordinate detecting part and a magnifying and displaying part. The display part has a display area on which a plurality of images are displayed. The distance detecting part detects a space distance between an indication body and the display area, the indication body being used for indicating the image displayed on the display area by a user. The coordinate detecting part detects coordinates on the display area corresponding to a position of the indication body when the space distance detected by the distance detecting part is equal or less than a predetermined first threshold value. The magnifying and displaying part, when detected coordinates detected by the coordinate detecting part are not varied for a predetermined limit time or more, executes magnifying and displaying process magnifying a periphery image displayed on a periphery area with predetermined dimensions including the detected coordinates on the display area by a predetermined magnification ratio to create a periphery magnification image and displaying the periphery magnification image with superimposing the periphery magnification image on the periphery image.

In accordance with the present disclosure, an electronic apparatus includes the above-mentioned display controlling device and an instruction receiving part. The instruction receiving part, when the space distance detected by the distance detecting part becomes equal or less than a second threshold value smaller than the first threshold value, receives an instruction corresponding to the image displayed with include the detected coordinates on the display area.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view of an external appearance of a copying machine according to an embodiment of an electronic apparatus in accordance with the present disclosure.

FIG. 2 is a block diagram of an electric configuration of the copying machine according to the embodiment of the electronic apparatus in accordance with the present disclosure.

FIG. 3 is a graph plotting a space distance, which is pointed between an indication body and a display area, and a magnitude of variation of electrostatic capacity in the display area in the copying machine according to the embodiment of the electronic apparatus in accordance with the present disclosure.

FIG. 4 is a plan view showing an operation screen displayed on the display area in the copying machine according to the embodiment of the electronic apparatus in accordance with the present disclosure.

FIG. 5 is a flowchart useful for understanding an action when the indication body is brought close to an image displayed on the display area in the copying machine according to the embodiment of the electronic apparatus in accordance with the present disclosure.

FIG. 6 is a flowchart useful for understanding an action when execution of magnifying and displaying process is started in the copying machine according to the embodiment of the electronic apparatus in accordance with the present disclosure.

FIG. 7 is a plan view showing the operation screen when execution of magnifying and displaying process is started in the copying machine according to the embodiment of the electronic apparatus in accordance with the present disclosure.

FIG. 8 is a plan view showing the operation screen when the indication body is not moved in a parallel direction after magnifying and displaying process is started in the copying machine according to the embodiment of the electronic apparatus in accordance with the present disclosure.

FIG. 9 is a flowchart useful for understanding an action during magnifying and displaying process is executed in the copying machine according to the embodiment of the electronic apparatus in accordance with the present disclosure.

FIG. 10 is a plan view showing the operation screen when the indication body is moved during magnifying and displaying process is executed in the copying machine according to the embodiment of the electronic apparatus in accordance with the present disclosure.

### DETAILED DESCRIPTION

In the following, an embodiment of an electronic apparatus according to the present disclosure will be described with reference to the drawings. Incidentally, in the embodiment, although a copying machine is described as an example of the electronic apparatus, the electronic apparatus is not restricted by this. The electronic apparatus may be, for example, an image forming apparatus, such as a printer, a facsimile device or a scanner, a multifunction peripheral having functions of these image forming apparatuses, a game machine, a mobile phone or a car navigation device.

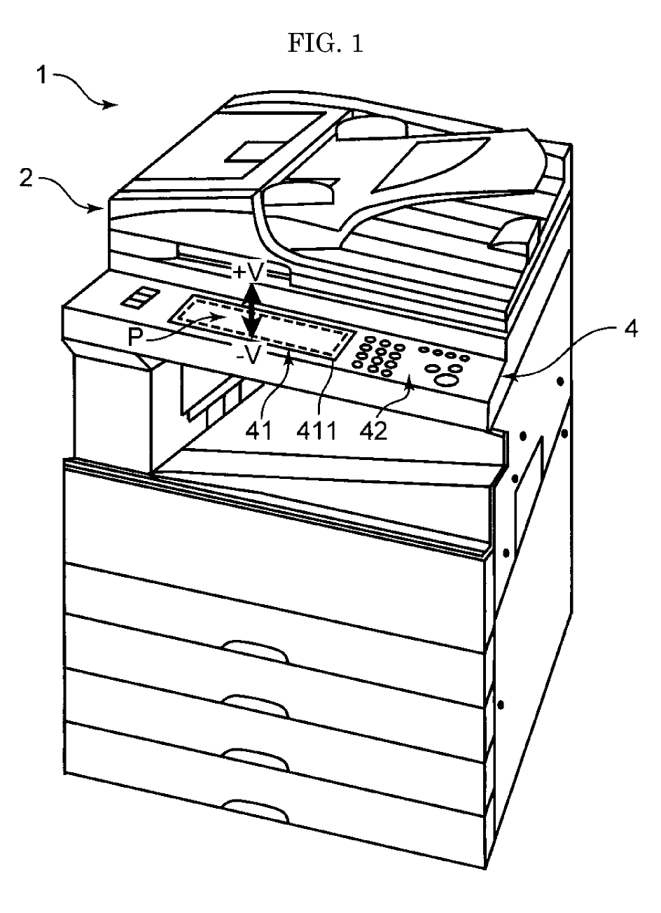

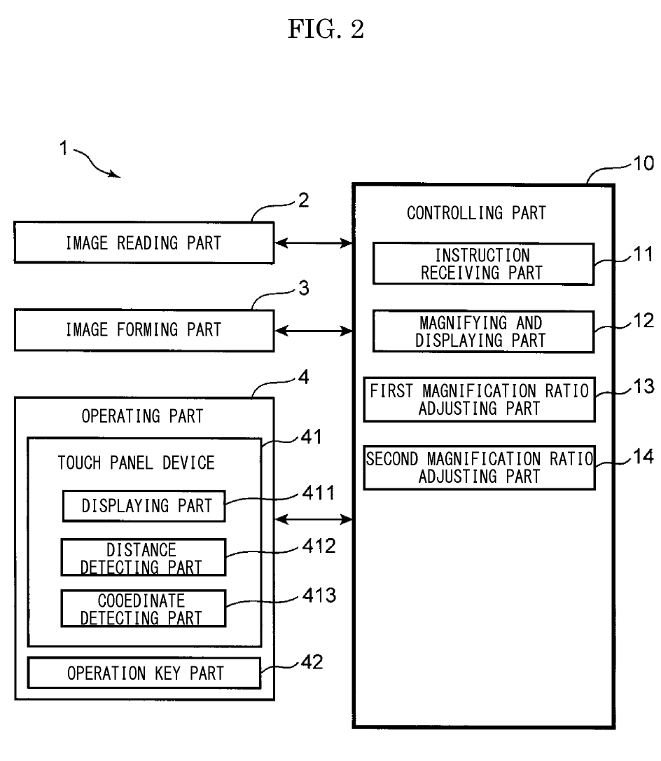

FIG. 1 is an outline view of the copying machine 1 according to the embodiment of the electronic apparatus in accordance with the present disclosure. FIG. 2 is a block diagram showing an electric configuration of the copying machine 1. As shown in FIGS. 1 and 2, the copying machine 1 includes an image reading part 2, an image forming part 3, an operating part 4 and a controlling part 10.

The image reading part 2 is arranged in an upper part of the copying machine 1 as shown in FIG. 1. The image reading part 2 includes an optical unit (not shown) having a CCD (Charged Coupled Device) line sensor, an exposure lump and others. The image reading part 2 is controlled by the controlling part 10 so as to make the optical unit read an image of a document, to create image data representing the image of the document and to output the image data to the controlling part 10.

The image forming part 3 is arranged inside of the copying machine 1. The image forming part 3 is controlled by the controlling part 10 to form the image onto a sheet on the basis of the image data inputted in the controlling part 10. Concretely, the image forming part 3 has a known structure including a photosensitive drum, a charging part, an exposing part, a developing part, a transferring part and others. The charging part is arranged to face to a circumference face of the photosensitive drum. The exposing part is arranged to face to the circumference face of the photosensitive drum at a downstream side of the charging part. The developing part is arranged to face to the circumference face of the photosensitive drum at a downstream side of the exposing part. The transferring part is arranged to face to the circumference face of the photosensitive drum at a downstream side of the developing part.

The operating part 4 is arranged in a front part of the copying machine 1 as shown in FIG. 1. The operating part 4 is configured capable of inputting various operating instruction by a user. Concretely, the operating part 4 includes a touch panel device 41 and an operation key part 42.

The touch panel device 41 includes a display part 411, such as a liquid crystal display, having a display area P for displaying the image. The touch panel device has an electrostatic capacitive type touch panel function. The touch panel device 41 works as a distance detecting part 412 and a coordinate detecting part 413 by using the touch panel function.

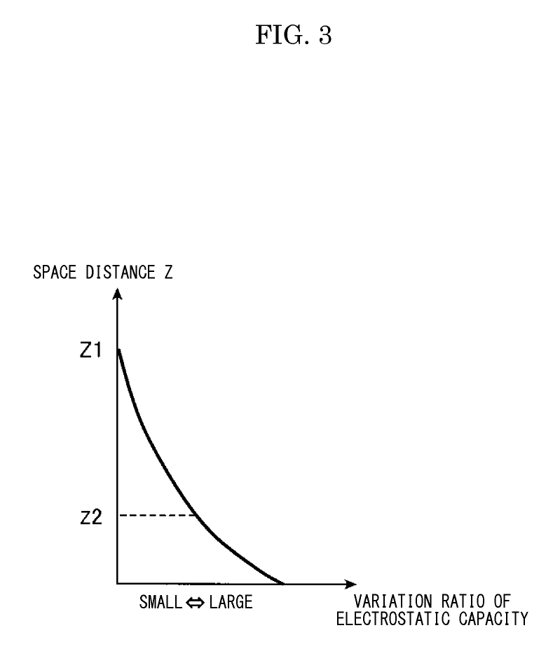

FIG. 3 is a graph showing a relationship of an space distance Z between an indication body and the display area P and a magnitude of variation of electrostatic capacity in the display area P. The space distance Z means a distance in a direction orthogonal to the display area P (an arrow direction in FIG. 1 (±V direction)). Hereinafter, the direction orthogonal to the display area P (the arrow direction in FIG. 1 (±V direction)) is called as upward and downward directions. In the upward and downward directions, a direction close to the display area P is called as the downward direction and a direction far from the display area P is called as the upward direction.

The graph in FIG. 3 is determined based on experiment values in test run or the like and stored in ROM (Read Only Memory) (not shown) or the like in the touch panel device 41. As shown in the graph of FIG. 3, the touch panel function had by the touch panel device 41 can detect the variation of the electrostatic capacity varied in the display area P in a case where the space distance Z between the indication body, such as a finger of the user or a pen, and the display area P is equal or less than a first threshold value Z1.

The distance detecting part 412, when the magnitude of the variation of the electrostatic capacity in the display area P is detected by the touch panel function, converts the detected magnitude of the variation of the electrostatic capacity to the space distance Z by using the graph of FIG. 3 stored in the above-mentioned ROM. The distance detecting part 412 outputs a detection signal indicating the space distance Z to the controlling part 10. Thus, the distance detecting part 412 detects the space distance Z between the indication body and the displaying area P.

The coordinate detecting part 413, in a case where the space distance Z is detected by the distance detecting part 412, i.e. a case where the space distance Z between the indication body and the display area P is equal or less than the first threshold value Z1, outputs a detection signal indicating a position of coordinates on the display area P at which the variation of the electrostatic capacity is detected by the touch panel function. Thus, the coordinate detecting part 413 detects the coordinates on the display area P corresponding to the position of the indication body in a case where the space distance Z detected by the distance detecting part 412 is equal or less than the first threshold value Z1.

Incidentally, the touch panel device 41 is not restricted by the electrostatic capacitive type touch panel function. For example, the touch panel device 41 may have an ultrasonic type or optical type touch panel function. The touch panel device 41 may work similar to the above-mentioned distance detecting part 412 and the above-mentioned coordinate detecting part 413 with fitting to the type of the touch panel function.

The operation key part 42 includes various keys, for example, numeric keys for inputting numerical values and marks, cursor keys for moving a pointer (a cursor) displayed on the display part 411 and others.

The controlling part 10 is arranged inside the copying machine 1. The controlling part 10 controls an action of each component of the copying machine 1. Concretely, the controlling part 10 includes a CPU (Central Processing Unit) (not shown) executing predetermined arithmetic processes, a nonvolatile memory (not shown), such as an EEPROM (Electrically Erasable Programmable Read Only Memory), storing predetermined control programs, a RAM (Random Access Memory) (not shown) storing temporarily data, a timer (not shown) timing a current time, their peripheral circuits and others.

The controlling part 10 works, for example, as an instruction receiving part 11, a magnifying and displaying part 12, a first magnification ratio adjusting part 13 and a second magnification ratio adjusting part 14 by making the CPU execute the control program stored in the nonvolatile memory or the like.

The instruction receiving part 11 receives various instruction to the copying machine 1 inputted by operating the operation key part 42. The instruction receiving part 11 receives various instruction to the copying machine 1 chosen by touch operation of the image displayed on the display area P with the indication body.

The instruction receiving part 11, when receiving various instruction to the copying machine 1 by the latter way, displays the image representing an operation screen onto the display area P, wherein, on the operation screen, a plurality of alternative images are arranged for choosing with the indication body by the user. Hereinafter, the image representing the operation screen is called as merely the operation screen.

There is a case where, when the user moves the indication body in the downward direction to bring it close to the alternative image, the space distance Z detected by the distance detecting part 412 becomes equal or less than a second threshold value Z2 (refer to FIG. 3) smaller than the first threshold value Z1. In this case, the instruction receiving part 11 decides that the alternative image displayed at the position of the coordinates detected by the coordinate detecting part 413 is chosen by touch operation and receives instruction corresponding to the alternative image.

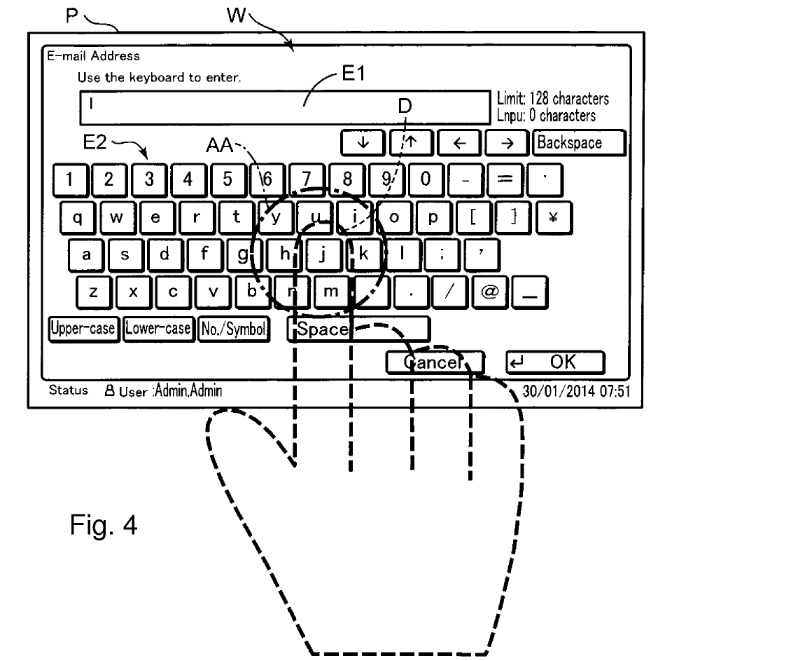

FIG. 4 is the figure showing the operation screen W displayed on the display area P. Concretely, the instruction receiving part 11 displays, for example, the operation screen W shown in FIG. 4 on the display area P. The operation screen W includes an image E1 representing an input box for inputting characters and marks and an image E2 representing a key board in which keys with characters and marks are arranged as the alternative images. Hereinafter, the image E1 representing the input box is called as the input box E1 and the image E2 representing the key board is called as the key board E2.

There is a case where, when the operation screen W is displayed on the display area P, the user moves the indication body D in the downward direction to bring it close to a key pointing to a character “j”, and accordingly, the space distance Z detected by the distance detecting part 412 becomes equal or less than a second threshold value Z2. In this case, the instruction receiving part 11 decides that the alternative image pointing to the character “j” is chosen by the user and receives input instruction of the character “j” corresponding to the alternative image. Subsequently, the controlling part 10 displays the character “j” on the input box E1 in accordance with the input instruction received by the instruction receiving part 11.

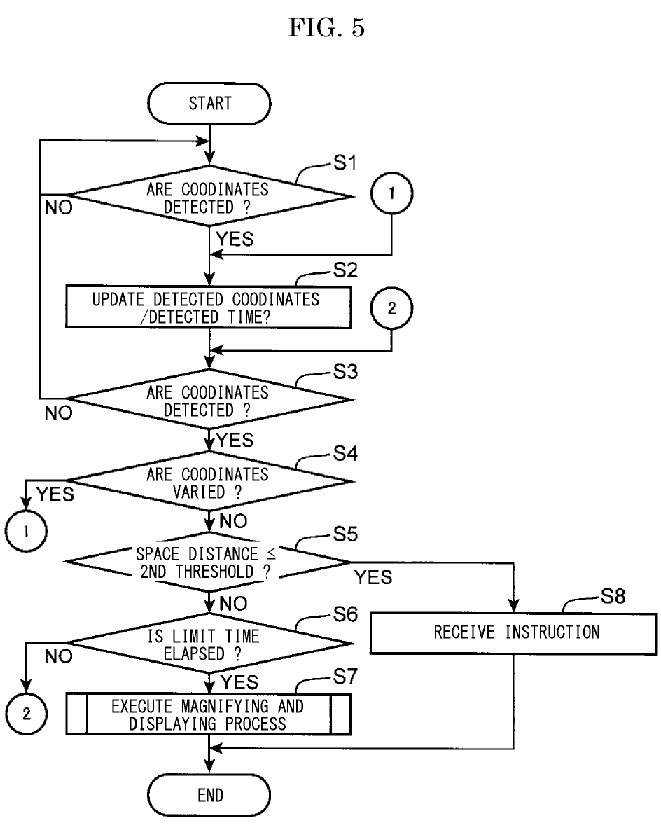

In the following, an action when the indication body D is brought close to the image displayed on the display area P will be described. In the description, the magnifying and displaying part 12, the first magnification ratio adjusting part 13 and the second magnification ratio adjusting part 14 will be described in detail. Incidentally, as a concrete example, an action when the indication body D is brought close to the keys (the alternative images) pointing the characters and the marks, in a case where the operation screen W shown in FIG. 4 is displayed on the display area P, will be described as follows. FIG. 5 is a flowchart showing an action when the indication body D is brought close to the image displayed on the display area P.

There is a case where the user moves the indication body D in the downward direction, for example, to bring the indication body D close to the image pointing the character or the mark included in the key board E2 shown in FIG. 4. As a result, as shown in FIG. 5, the space distance Z detected by the distance detecting part 412 may become equal or less than the first threshold value Z1 and the coordinate detecting part 413 detects the coordinates on the display area P corresponding to the indication body D (step S1: YES). Hereinafter, the coordinates detected by the coordinate detecting part 413 is called as detected coordinates.

In such a case, the magnifying and displaying part 12 uses the timer in the controlling part 10 to obtain a time when the detected coordinates are detected at step S1, as a detected time, and stores the detected coordinates and the detected time in the RAM (step S2).

After step S2 is executed, the user moves the indication body D in a parallel direction in a condition where the space distance Z between the indication body D and the display area P is equal or less than the first threshold value Z1. The parallel direction means a direction along a plane parallel to the display area P. In such a case, the coordinate detecting part 413 detects the coordinates after the movement (step S3: YES) and the detected coordinates after the movement are different from the detected coordinates stored in the RAM. In such a case, the magnifying and displaying part 12 decides that the detected coordinates are varied (step S4: YES) and re-executes step S2.

The magnifying and displaying part 12 updates the detected coordinates before the movement stored in the RAM, at re-executed step S2, by the detected coordinates after the movement detected at step S3. The magnifying and displaying part 12 uses the timer in the controlling part 10 to obtain a current time when the detected coordinates after the movement are detected, as the detected time, and updates the detected time when the detected coordinates before the movement is detected stored in the RAM by the obtained detected time.

On the other hand, after step S2 is executed, there is a case where, when the user moves the indication body D in the upward direction, the space distance Z between the indication body D and the display area P becomes larger than the first threshold value Z1 and the coordinate detecting part 413 does not detect the coordinates (step S3: NO). In this case, processes of step S1 and later are repeated.

Alternatively, after step S2 is executed, there is a case where the user does not move the indication body D in the parallel direction and moves the indication body D only in the downward direction. In this case, the coordinate detecting part 413 detects the coordinates (step S3: YES) and the detected coordinates becomes equal to the detected coordinates stored in the RAM. In such a case, the magnifying and displaying part 12 decides that the detected coordinates are not varied (step S4: NO).

At step S4, when the magnifying and displaying part 12 decides that the detected coordinates are not varied (step S4: NO), there is a case where the space distance Z detected by the distance detecting part 412 becomes equal or less than the second threshold value Z2 (step S5: YES). In this case, the instruction receiving part 11 receives the instruction corresponding to the image displayed at the position of the detected coordinates stored in the RAM (step S8). As a result, the controlling part 10 operates the copying machine 1 in accordance with the instruction received by instruction receiving part 11 at step S8 and finishes the action shown in FIG. 5. Incidentally, when finishing the action shown in FIG. 5, the controlling part 10 deletes the detected coordinates and the detected time stored in the RAM.

On the other hand, at step S4, when the magnifying and displaying part 12 decides that the detected coordinates are not varied (step S4: NO), there is a case where the space distance Z detected by the distance detecting part 412 is not equal or less than the second threshold value Z2 (step S5: NO). In this case, the magnifying and displaying part 12 uses the timer in the controlling part 10 to obtain a current time and decides whether or not the obtained current time is a time after a predetermined limit time is elapsed from the detected time stored in the RAM (step S6). That is, at step S6, the magnifying and displaying part 12 decides whether or not the predetermined limit time is elapsed in a condition where the detected coordinates are not varied.

Incidentally, the limit time used at step S6 is determined, for example, by a time (e.g. 3 seconds) longer than a conceivable time stopping instantly the movement of the indication body D in order to recognize that the indication body D exists on an upper part of the image as the subject of the touch operation and stored in the nonvolatile memory in the controlling part 10.

At step S6, in a case where the magnifying and displaying part 12 decides that the predetermined limit time is not elapsed in the condition where the detected coordinates are not varied (step S6: NO), processes of step S3 and later are repeated. After that, when the magnifying and displaying part 12 decides at step S6 that the predetermined limit time is elapsed in the condition where the detected coordinates are not varied (step S6: YES), the magnifying and displaying part 12 executes magnifying and displaying process.

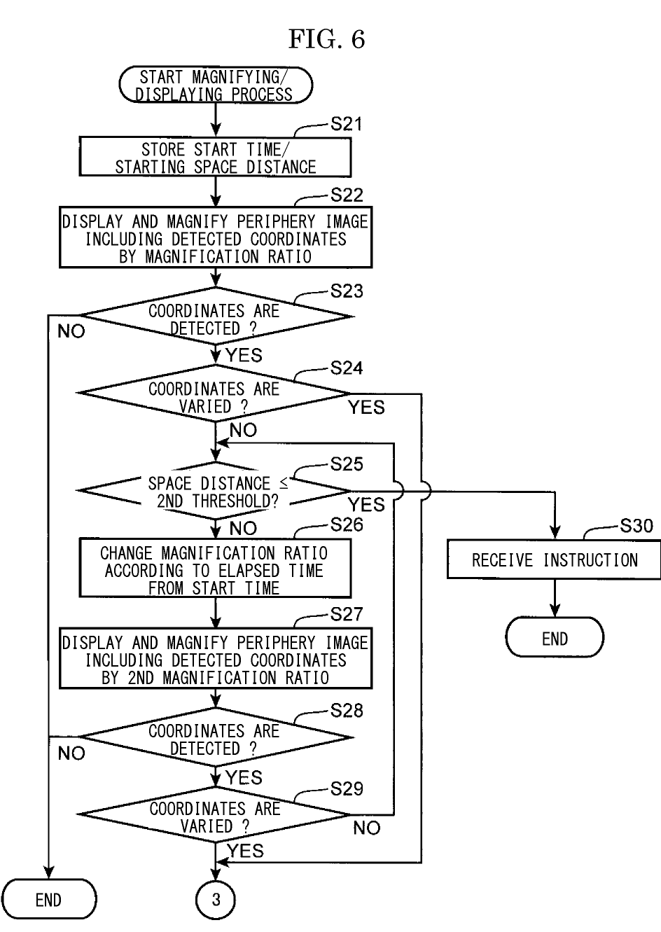

In the following, an action of the magnifying and displaying process will be described. FIG. 6 is a flowchart showing an action when execution of the magnifying and displaying process is started. As shown in FIG. 6, when the magnifying and displaying part 12 starts the execution of the magnifying and displaying process, the magnifying and displaying part 12 obtains a current time by using the timer in the controlling part 10 and stores the obtained current time, as a start time when the execution of the magnifying and displaying process is started, in the RAM. When the magnifying and displaying part 12 starts the execution of the magnifying and displaying process, the magnifying and displaying part 12 stores the space distance Z detected by the distance detecting part 412 as a starting space distance in the RAM (step S21).

The magnifying and displaying part 12 creates a periphery magnification image by magnifying a periphery image displayed on a periphery area with predetermined dimensions having the detected coordinates stored in the RAM by a predetermined magnification ratio. The magnifying and displaying part 12 displays the created periphery magnification image with superimposing it on the periphery image (step S22). The magnification ratio used at step S22 is determined by a magnification ratio (e.g. approximately 1.2 times) capable of making the user recognizing that the periphery magnification image is an image taken by magnifying the periphery image and stored in the nonvolatile memory in the controlling part 10 in advance.

Here, step S22 will be described in detail. For example, as shown in FIG. 4, there is a case where the limit time is elapsed in a condition where the indication body D exists on the upper part of the image pointing to the character “j” and the execution of the magnifying and displaying process of step S6 is started. In this case, at step S2, the coordinates corresponding to the position of the image pointing to the character “j” is stored as the detected coordinates in the RAM.

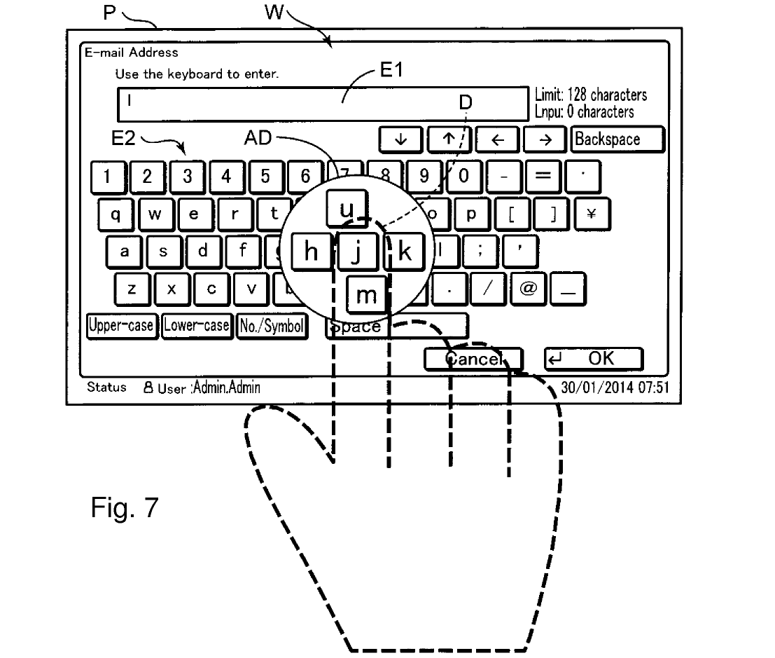

In such a case, the magnifying and displaying part 12 uses the images pointing five characters “u”, “h”, “j”, “k” and “m” displayed on the periphery area AA with the predetermined dimensions (a portion of a dot chain line in FIG. 4) having the detected coordinates as the periphery image at step S22. FIG. 7 is the figure showing the operation screen W when the execution of the magnifying and displaying process is started. The magnifying and displaying part 12 creates the periphery magnification image AD created by magnifying the periphery image by the predetermined magnification ratio as shown in FIG. 7 and displays the periphery magnification image AD with superimposing it on the periphery image.

Here, FIG. 6 is referred. As a result that the user visually recognizes the periphery magnification image AD displayed at step S22, there is a case where the user decides that the image to which the indication body D is brought close is not the image desired to choose and moves the indication body D in the upward direction. As a result, the space distance Z between the indication body D and the display area P may become larger than the first threshold value Z1 and the coordinate detecting part 413 may not detect the coordinates (step S23: NO). In this case, the magnifying and displaying part 12 finishes the execution of the magnifying and displaying process. Incidentally, when finishing the execution of the magnifying and displaying process, the magnifying and displaying part 12 deletes information of the detected coordinates and others stored in the RAM.

On the other hand, there is a case where the user does not move the indication body D in the parallel direction in order to recognize whether or not the image desired to choose is included in the periphery magnification image AD displayed at step S22. Alternatively, there is a case where the user intends to move the indication body D in the downward direction in order to choose the image in a lower part of the indication body D, but does not move the indication body D in the parallel direction.

In these cases, the coordinate detecting 413 detects the coordinates (step S23: YES) and the detected coordinates are equal to the detected coordinates stored in the RAM. In such a case, the magnifying and displaying part 12 decides that the detected coordinates are not varied (step S24: NO).

At step S24, when the magnifying and displaying part 12 decides that the detected coordinates are not varied (step S24: NO), there is a case where the space distance Z detected by the distance detecting part 412 becomes equal or less than the second threshold value Z2 (step S25: YES). In this case, the instruction receiving part 11 receives the instruction corresponding to the image displayed at the position of the detected coordinates stored in the RAM (step S30).

As a result, the controlling part 10 operates the copying machine 1 in accordance with the instruction received by instruction receiving part 11 at step S30. Moreover, the magnifying and displaying part 12 finishes the execution of the magnifying and displaying process. Accordingly, information of the detected coordinates and others stored in the RAM is deleted.

On the other hand, at step S24 when the magnifying and displaying part 12 decides that the detected coordinates are not varied (step S24: NO), there is a case where the space distance Z detected by the distance detecting part 412 is not equal or less than the second threshold value Z2 (step S25: NO). In this case, the second magnification ratio adjusting part 14 obtains the predetermined magnification ratio stored in the nonvolatile memory and changes the obtained magnification ratio in accordance with an elapsed time from the starting time of the execution of the magnifying and displaying process. The second magnification ratio adjusting part 14 stores the changed magnification ratio in the RAM (step S26).

Concretely, at step S26, the second magnification ratio adjusting part 14 obtains a current time by using the timer in the controlling part 10. The second magnification ratio adjusting part 14 calculates the elapsed time elapsed to the obtained current time from the start time when the execution of the magnifying and displaying process is started stored in the RAM. The second magnification ratio adjusting part 14 obtains the predetermined magnification ratio stored in the nonvolatile memory and changes the obtained magnification ratio so that the magnification ratio becomes larger as the calculated elapsed time is prolonged. The second magnification ratio adjusting part 14 stores the changed magnification ratio as the second magnification ratio in the RAM (step S27).

In such a case, the magnifying and displaying part 12 magnifies the periphery image used at step S22 by the second magnification ratio stored in the RAM at step S26. The magnifying and displaying part 12 displays the magnified image as new periphery magnification image AD in place of the periphery magnification image AD displayed at step S22 with superimposing it on the periphery image (step S27).

Here, step S26 and S27 will be described in detail. For example, as shown in FIG. 7, there is a case where the limit time is elapsed in a condition where the indication body D exists on the upper part of the image pointing to the character “j” and the execution of the magnifying and displaying process of step S6 is started. After that, at step S22, the periphery magnification image AD created by magnifying the periphery image composed of the images pointing five characters “u”, “h”, “j”, “k” and “m” by the predetermined magnification ratio may be superimposed and displayed on the periphery image. In this case, at step S2, the coordinates corresponding to the position of the image pointing the character “j” is stored as the detected coordinates in the RAM.

There is a case where the indication body D is not moved in the parallel direction in a condition where the periphery magnification image AD is displayed and step S26 is executed. In this case, at step S26, the second magnification ratio adjusting part 14 calculates, as mentioned above, the elapsed time elapsed to the current time from the start time when the execution of the magnifying and displaying process is started. The second magnification ratio adjusting part 14 changes the obtained magnification ratio obtained from the nonvolatile memory so that the magnification ratio becomes larger as the calculated elapsed time is prolonged. The second magnification ratio adjusting part 14 stores the changed magnification ratio as the second magnification ratio in the RAM.

Concretely, the second magnification ratio adjusting part 14 adds a product of the calculated elapsed time and 0.1 to the magnification ratio obtained from the nonvolatile memory, thereby changing the obtained magnification ratio so that the magnification ratio becomes larger as the calculated elapsed time is prolonged. For example, if the calculated elapsed time is 1 second and the magnification ratio obtained from the nonvolatile memory is 1.2, the second magnification ratio adjusting part 14 takes 1.3 of a result of adding 0.1 to 1.2 as the changed magnification ratio. Incidentally, the above-described changing manner of the magnification ratio of the second magnification ratio adjusting part 14 is merely one example. Any manner may be applied to the changing manner, so long as the obtained magnification ratio becomes larger as the elapsed time from the start time when the execution of the magnifying and displaying process is started is prolonged.

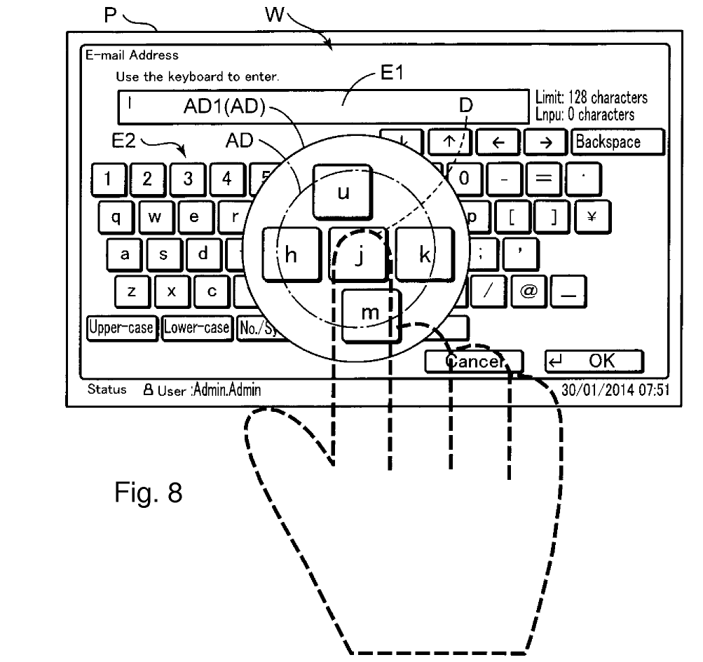

At step S27, the magnifying and displaying part 12 magnifies the periphery image used at step S22 by the second magnification ratio stored in the RAM at step S26. FIG. 8 is the figure showing the operation screen W when the indication body D is not moved in a parallel direction after the execution of the magnifying and displaying process is started. The magnifying and displaying part 12 displays the image AD1 created by magnifying the periphery image by the second magnification ratio at step S27 as new periphery magnification image AD in place of the periphery magnification image AD (a portion of a dot chain line in FIG. 8) displayed at step S22 with superimposing it on the periphery image.

Here, FIG. 6 is referred. As a result that the user visually recognizes the periphery magnification image AD displayed at step S27, there is a case where the user decides that the image to which the indication body D is brought close is not the image desired to choose and moves the indication body D in the upward direction. As a result, the space distance Z between the indication body D and the display area P may become larger than the first threshold value Z1 and the coordinate detecting part 413 may not detect the coordinates (step S28: NO). In this case, the magnifying and displaying part 12 finishes the execution of the magnifying and displaying process. Accordingly, information of the detected coordinates and others stored in the RAM is deleted.

On the other hand, there is a case where the user does not move the indication body D in the parallel direction in order to recognize whether or not the image desired to choose is included in the periphery magnification image AD displayed at step S27. Alternatively, there is a case where the user intends to move the indication body D in the downward direction in order to choose the image in the lower part of the indication body D, but does not move the indication body D in the parallel direction.

In these cases, the coordinate detecting 413 detects the coordinates (step S28: YES) and the detected coordinates are equal to the detected coordinates stored in the RAM. In such a case, the magnifying and displaying part 12 decides that the detected coordinates are not varied (step S29: NO) and carries out processes of step S25 and later again. Incidentally, at step 26 carried out when the processes of step S25 and later are carries out again, the second magnification ratio adjusting part 14 updates the second magnification ratio stored in the RAM by the changed magnification ratio at step S26.

On the other hand, as a result that the user visually recognizes the periphery magnification image AD displayed at step S22, there is a case where the user decides that the image to which the indication body D is brought close is not the image desired to choose. Subsequently, the user may move the indication body D in the parallel direction in a condition where the space distance Z between the indication body D and the display area P is kept equal or less than the first threshold value Z1, in order to find the image desired to choose.

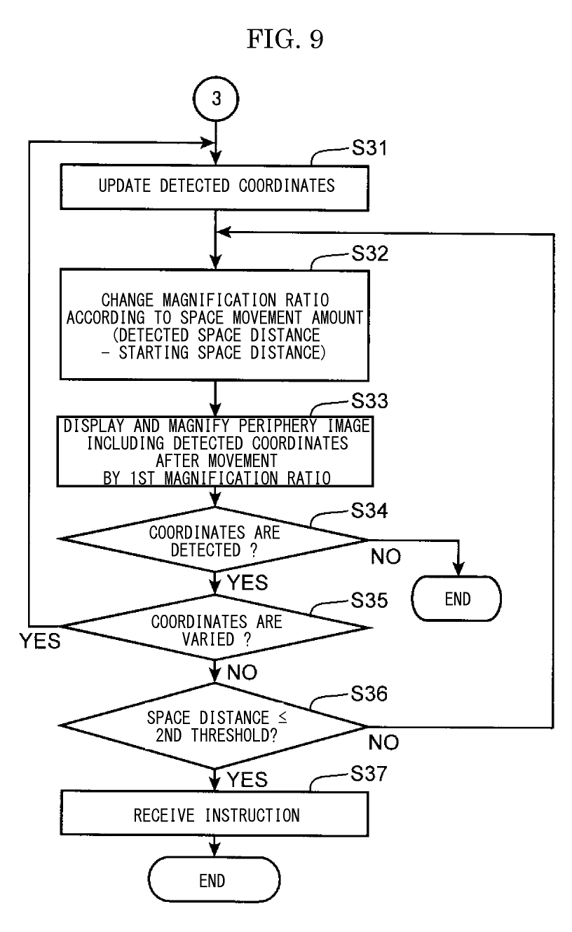

In this case, the coordinate detecting part 413 detects the coordinates after the movement (step S23: YES) and the detected coordinates after the movement are different from the detected coordinates stored in the RAM. In such a case, the magnifying and displaying part 12 decides that the detected coordinates are varied (step S24: YES) and process is shifted to the action shown in FIG. 9.

Similarly, as a result that the user visually recognizes the periphery magnification image AD displayed at step S27, there is a case where the user decides that the image to which the indication body D is brought close is not the image desired to choose. Subsequently, the user may move the indication body D in the parallel direction in a condition where the space distance Z between the indication body D and the display area P is kept equal or less than the first threshold value Z1, in order to find the image desired to choose.

Also in this case, the coordinate detecting part 413 detects the coordinates after the movement (step S28: YES) and the detected coordinates after the movement are different from the detected coordinates stored in the RAM. In such a case, the magnifying and displaying part 12 decides that the detected coordinates are varied (step S29: YES) and process is shifted to the action shown in FIG. 9.

FIG. 9 is a flowchart showing an action during the magnifying and displaying process is executed. When the magnifying and displaying part 12 decides at step S24 or step S29 that the detected coordinates are varied (step S24: YES, step S29: YES), the magnifying and displaying part 12 updates the detected coordinates stored in the RAM by the detected coordinates after the movement detected at step S23 or step S28 (step S31).

In such a case, the first magnification ratio adjusting part 13 changes the second magnification ratio stored in the RAM or the magnification ratio stored in the nonvolatile memory in accordance with a space movement amount obtained by subtracting the starting space distance stored in the RAM from the space distance Z detected by the distance detecting part 412. The first magnification ratio adjusting part 13 stores the changed magnification ratio as a first magnification ratio in the RAM (step S32).

Concretely, at step S32, the first magnification ratio adjusting part 13 obtains the starting space distance stored in the RAM. The first magnification ratio adjusting part 13 subtracts the obtained starting space distance from the space distance Z detected by the distance detecting part 412. The first magnification ratio adjusting part 13 takes the subtracted result as the space movement amount of the movement of the indication body D in the upward and downward directions from the start of the execution of the magnifying and displaying process.

The first magnification ratio adjusting part 13 obtains the second magnification ratio from the RAM when step S26 has been executed to store the second magnification ratio in the RAM. On the other hand, the first magnification ratio adjusting part 13 obtains the magnification ratio from the nonvolatile memory when step S26 is not executed and the second magnification ratio is not stored in the RAM. The first magnification ratio adjusting part 13 changes the obtained magnification ratio so that the magnification ratio becomes larger as the calculated space movement amount becomes small.

In such a case, the magnifying and displaying part obtains the detected coordinates after the movement stored in the RAM and obtains the image displayed on the periphery image including the detected coordinates as new periphery image. The magnifying and displaying part 12 magnifies the obtained new periphery image by the first magnification ratio stored in the RAM at step S32. The magnifying and displaying part 12 displays the image created by magnifying the new periphery image by the first magnification ratio as new periphery magnification image AD in place of the already displayed periphery magnification image AD with superimposing it on the new periphery image (step S33).

Here, step S32 and S33 will be described in detail. For example, as shown in FIG. 7, there is a case where the limit time is elapsed in a condition where the indication body D exists on the upper part of the image pointing to the character “j” and the execution of the magnifying and displaying process of step S6 is started. After that, at step S22, the periphery magnification image AD created by magnifying the periphery image composed of the images pointing five characters “u”, “h”, “j”, “k” and “m” by the magnification ratio stored in the nonvolatile memory may be superimposed and displayed on the periphery image.

Alternatively, after step S22 is executed, there is a case where the indication body D is not moved in the parallel direction in a condition where the indication body D exists on the upper part of the image pointing to the character “j” and, at step S27, as shown in FIG. 8, the periphery magnification image AD1 created by magnifying the periphery image composed of the images pointing five characters “u”, “h”, “j”, “k” and “m” by the second magnification ratio stored in the RAM may be superimposed and displayed on the periphery image.

Incidentally, in the following, in order to simplify the description, it is described so that the magnification ratio stored in the nonvolatile memory and the second magnification ratio stored in the RAM are equal to each other. That is, after step S22 and step S27 are executed, as shown in FIG. 7, the periphery magnification image AD may be superimposed and displayed on the periphery image composed of the images pointing five characters “u”, “h”, “j”, “k” and “m”.

There is a case where, in a condition where the periphery magnification image AD is displayed as shown in FIG. 7, the indication body D is moved on the upper part of the image pointing to the character “j” (step S24: YES, or step S29: YES) and the indication body D is moved in the downward direction. That is, the indication body D may be brought close to the display area P from the start of the execution of the magnifying and displaying process. In this case, at step S31, the detected coordinates stored in the RAM is updated by the detected coordinates corresponding to a position where the image pointing a mark “]” exists.

In such a case, the first magnification ratio adjusting part 13 calculates the space movement amount at step 32 as described above. The first magnification ratio adjusting part 13 obtains the second magnification ratio from the RAM or obtains the magnification ratio from the nonvolatile memory. The first magnification ratio adjusting part 13 changes the obtained magnification ratio so that the magnification ratio becomes larger as the calculated space movement amount becomes small.

In the concrete example, since the indication body D is brought close to the display area P as compared with a time when the execution of the magnifying and displaying process is started, the space distance Z detected by the distance detection part 412 is shorter than the starting space distance. Therefore, the space movement amount obtained by subtracting the starting space distance from the space distance Z becomes a negative value. That is, as compared with the time when the execution of the magnifying and displaying process is started, the space movement amount is decreased as the indication body D is brought closer to the display area P.

Thereupon, the first magnification ratio adjusting part 13 subtracts a product of the calculated space movement amount and 0.1 from the magnification ratio obtained from the RAM or the nonvolatile memory, thereby changing the obtained magnification ratio so that the magnification ratio becomes larger as the calculated space movement amount becomes small. For example, there is a case where the calculated space movement amount is −1 mm and the obtained magnification ratio is 1.2. In this case, the first magnification ratio adjusting part 13 takes 1.3 of a result of subtracting −0.1 from 1.2 as the changed magnification ratio. Incidentally, the above-described changing manner of the magnification ratio of the first magnification ratio adjusting part 13 is merely one example. Any manner may be applied to the changing manner, so long as the obtained magnification ratio becomes larger as the space movement amount becomes small.

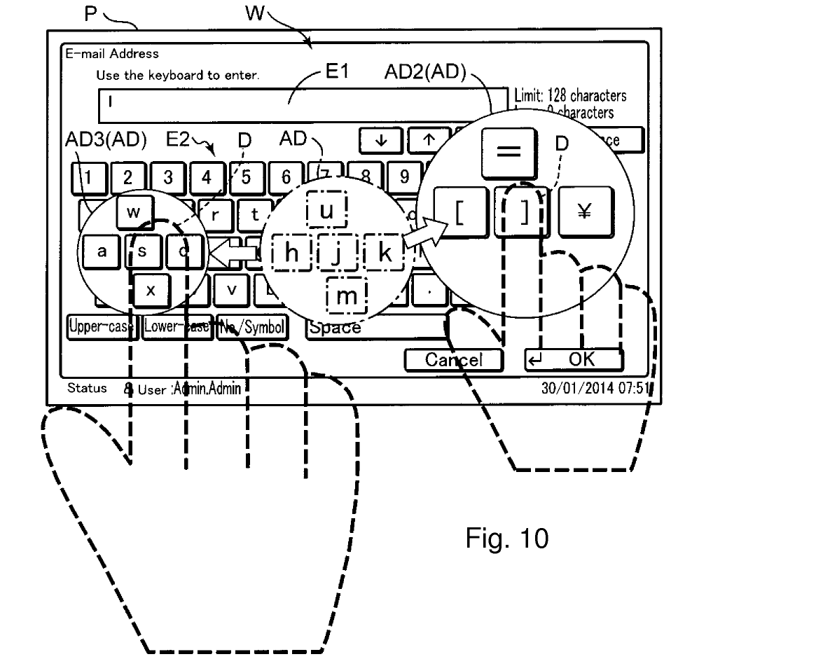

The magnifying and displaying part 12 obtains, at step S33, the detected coordinates after the movement stored in the RAM and obtains the image pointing four marks “=”, “[”, “]” and “¥” (refer to FIG. 7) displayed on the periphery image including the detected coordinates as new periphery image. The magnifying and displaying part 12 magnifies the obtained new periphery image by the first magnification ratio (in the concrete example, 1.3) stored in the RAM at step S32. FIG. 10 is the figure showing the operation screen W when the indication body D is moved during the magnifying and displaying process is executed. The magnifying and displaying part 12 displays the image AD2 created by magnifying the new periphery image by the first magnification ratio at step S32 as new periphery magnification image AD in place of the already displayed periphery magnification image AD (a portion of a dot chain line in FIG. 10) with superimposing it on the new periphery image, as shown in FIG. 10. Thereby, the periphery magnification image AD is moved and displayed to follow variation of the detected coordinates according to the movement of the indication body D in the parallel direction.

On the other hand, there is a case where the indication body D is moved on an upper part of the image pointing a character “s” in a condition where the periphery magnification image AD is displayed as shown in FIG. 7 (step S24: YES, or step S29: YES) and the indication body D is moved in the upward direction. That is, the indication body D may be brought far from the display area P from the start of the execution of the magnifying and displaying process. In this case, at step S31, the detected coordinates stored in the RAM is updated by the detected coordinates corresponding to a position where the image pointing a character “s” exists.

In such a case, the first magnification ratio adjusting part 13 calculates the space movement amount at step S32 as described above. The first magnification ratio adjusting part 13 obtains the second magnification ratio from the RAM or obtains the magnification ratio from the nonvolatile memory. The first magnification ratio adjusting part 13 changes the obtained magnification ratio so that the magnification ratio becomes larger as the calculated space movement amount becomes small.

In the concrete example, since the indication body D is brought far from the display area P as compared with a time when the execution of the magnifying and displaying process is started, the space distance Z detected by the distance detection part 412 is longer than the starting space distance. Therefore, the space movement amount obtained by subtracting the starting space distance from the space distance Z becomes a positive value. That is, as compared with the time when the execution of the magnifying and displaying process is started, the space movement amount is increased as the indication body D is brought far from the display area P.

Thereupon, the first magnification ratio adjusting part 13 subtracts a product of the calculated space movement amount and 0.1 from the magnification ratio obtained from the RAM or the nonvolatile memory, thereby changing the obtained magnification ratio so that the magnification ratio becomes larger as the calculated space movement amount becomes small. For example, there is a case where the calculated space movement amount is 1 mm and the obtained magnification ratio is 1.2. In this case, the first magnification ratio adjusting part 13 takes 1.1 of a result of subtracting 0.1 from 1.2 as the changed magnification ratio. Incidentally, the above-described changing manner of the magnification ratio of the first magnification ratio adjusting part 13 is merely one example. Any manner may be applied to the changing manner, so long as the obtained magnification ratio becomes larger as the space movement amount becomes small.

In such a case, the magnifying and displaying part 12 obtains, at step S33, the detected coordinates after the movement stored in the RAM and obtains the image pointing five characters “w”, “a”, “s”, “d” and “x” (refer to FIG. 7) displayed on the periphery image including the detected coordinates as new periphery image. The magnifying and displaying part 12 magnifies the obtained new periphery image by the first magnification ratio (in the concrete example, 1.1) stored in the RAM at step S32. The magnifying and displaying part 12 displays the image AD3 created by magnifying the new periphery image by the first magnification ratio at step S32 as new periphery magnification image AD in place of the already displayed periphery magnification image AD (a portion of a dot chain line in FIG. 10) with superimposing it on the new periphery image as shown in FIG. 10.

Here, FIG. 9 is referred. As a result that the user visually recognizes the periphery magnification image AD displayed newly at step S33, there is a case where the user decides that the image to which the indication body D is brought close is not the image desired to choose and moves the indication body D in the upward direction. As a result, the space distance Z between the indication body D and the display area P may become larger than the first threshold value Z1 and the coordinate detecting part 413 may not detect the coordinates (step S34: NO). In this case, the magnifying and displaying part 12 finishes the execution of the magnifying and displaying process. Accordingly, information of the detected coordinates and others stored in the RAM is deleted.

On the other hand, there is a case where the user does not move the indication body D in the parallel direction in order to recognize whether or not the image desired to choose is included in the periphery magnification image AD displayed newly at step S33. Alternatively, there is a case where the user intends to move the indication body D in the downward direction in order to choose the image in the lower part of the indication body D, but does not move the indication body D in the parallel direction.

In these cases, the coordinate detecting 413 detects the coordinates (step S34: YES) and the detected coordinates are equal to the detected coordinates stored in the RAM. In such a case, the magnifying and displaying part 12 decides that the detected coordinates are not varied (step S35: NO).

At step S35, when the magnifying and displaying part 12 decides that the detected coordinates are not varied (step S35: NO), there is a case where the space distance Z detected by the distance detecting part 412 is not equal or less than the second threshold value Z2 (step S36: YES). In this case, the instruction receiving part receives the instruction corresponding to the image displayed at the position of the detected coordinates stored in the RAM (step S37).

As a result, the controlling part 10 operates the copying machine 1 in accordance with the instruction received by instruction receiving part 11 at step S37. The magnifying and displaying part 12 finishes the execution of the magnifying and displaying process. Further, information of the detected coordinates and others stored in the RAM is deleted.

On the other hand, at step S35, when the magnifying and displaying part 12 decides that the detected coordinates are not varied (step S35: NO), there is a case where the space distance Z detected by the distance detecting part 412 is not equal or less than the second threshold value Z2 (step S36: NO). In this case, the first magnification ratio adjusting part 13 executes step S32 again. Incidentally, when step S32 is executed again, the first magnification ratio adjusting part 13 updates the first magnification ratio stored in the RAM by the magnification ratio changed at step S32.

Alternatively, as a result that the user visually recognizes the periphery magnification image AD displayed newly at step S33, there is a case where the user decides that the image to which the indication body D is brought close is not the image desired to choose. Subsequently, the user may move the indication body D in the parallel direction in a condition where the space distance Z between the indication body D and the display area P is kept equal or less than the first threshold value Z1, in order to find the image desired to choose.

In this case, the coordinate detecting part 413 detects the coordinates after the movement (step S34: YES) and the detected coordinates after the movement are different from the detected coordinates stored in the RAM. In such a case, the magnifying and displaying part 12 decides that the detected coordinates are varied (step S35: YES). Moreover, processes of step S31 and later are repeated.

Thus, the magnifying and displaying part 12 executes the magnifying and displaying process (step S7) when the detected coordinates detected by the coordinate detecting part 413 is varied for the predetermined limit time or more (step S6: YES). In the magnifying and displaying process, the magnifying and displaying part 12 magnifies the periphery image displayed on the periphery area AA with the predetermined dimensions having the detected coordinates on the display area P by the predetermined magnification ratio and displays the magnified periphery magnification image with superimposing it on the periphery image (step S22). That is, by the touch panel device 41 and the controlling part 10, the display controlling device according to the present disclosure is configured.

Therefore, the user can display the periphery magnification image AD created by magnifying the periphery image displayed around in the periphery of the image to which the indication body D is brought close, only by waiting for the limit time with keeping the indication body D close to the image displayed on the display area P. As a result, the user can easily find a desired image from a plurality images as compared with a conventional case of taking labor bringing the indication body D close to the images one by one to magnify and display each image and labor recognizing the images one by one in a condition where the periphery images are visually recognized hardly to decide whether or not each magnified and displayed image is the desired image.

Moreover, when the detected coordinates is varied during the magnifying and displaying process is executed (step S24: YES, step S29: YES), the magnifying and displaying part 12 displays the image AD2, AD3 created by magnifying the periphery image after varying displayed on the periphery area including the detected coordinates after varying as new periphery magnification image AD in place of the periphery magnification image AD displayed before varying with superimposing it on the periphery image after varying (step S33). That is, when the detected coordinates is varied during the magnifying and displaying process is executed (step S24: YES, step S29: YES), the magnifying and displaying part 12 moves and displays the periphery magnification image AD so as to follow variation (step S33).

Therefore, only by moving the indication body D with keeping a condition where the periphery magnification image AD is displayed by executing the magnifying and displaying process, the user can visually recognize easily the image created by magnifying the image displayed in the periphery of the lower part of the indication body D after the movement.

Moreover, the first magnification ratio adjusting part 13 makes the magnification ratio large as the space movement amount becomes small (step S32), wherein the space movement amount is taken by subtracting the starting space distance, that is the space distance detected by the distance detecting part 412 when the execution of the magnifying and displaying process is started, from the space distance Z, that is detected by the distance detecting part 412, during the magnifying and displaying process is executed.

Therefore, by bringing the indication body D close to the display area P during the magnifying and displaying process is executed, the user can visually recognize the image displayed in the periphery of the lower part of the indication body D with magnifying the image more greatly.

Moreover, the second magnification ratio adjusting part 14 makes the magnification ratio large as the elapsed time from the start time is prolonged (step S26) until the detected coordinates are varied after the magnifying and displaying process is started (step S24: NO, step S29: NO).

Therefore, by prolonging the time during the indication body D is not moved after the execution of the magnifying and displaying process is started and the periphery magnification image AD is displayed, the user can visually recognize the image displayed in the periphery of the lower part of the indication body D with magnifying the image more greatly.

Moreover, the instruction receiving part 11 displays the image in which a plurality of alternative images are arranged for choosing with the indication body D by the user, as the image of the operation screen W as shown in FIG. 4 and other figures, on the display area P. The instruction receiving part 11 receives the instruction corresponding to the alternative image displayed with including the detected coordinates on the display area P (step S8, step S30, step S37), when the space distance Z between the indication body D and the display area P becomes equal or less than the second threshold value Z2 smaller than the first threshold value Z1 (step S5: YES, step S25: YES, step S36: YES).

Therefore, by executing the magnifying and displaying process after waiting with keeping the indication body D close to the alternative image displayed on the display area P until the limit time is elapsed, the user can visually recognize the image created by magnifying the alternative image and displayed in the periphery of the lower part of the indication body D. Thereby, the user can easily find the alternative image as the subject to choose.

Subsequently, when the desired alternative image is included in the magnified image, only by bringing the indication body D close to the desired alternative image so that the space distance Z between the indication body D and the display area P becomes equal or less than the second threshold value Z2, the user can make the instruction receiving part 11 receive the instruction corresponding to the desired alternative image.

Incidentally, the above-described embodiment is an example of an embodiment according to the present disclosure, but does not restrict the disclosure to the above-described embodiment. For example, the disclosure may be actualized in improved embodiments mentioned later.

For example, in a first improved embodiment, in a case where the image as an image showing a document, in which a plurality of images for visually recognizing are arranged and cannot be chosen by the indication body D, is displayed on the display area P, similarly to the above-described embodiment, it may be configured so that the magnifying and displaying part 12 executes the magnifying and displaying process. In this case, step S5, step S8, step S25, step S30, step S36 and step S37 may be omitted.

In a second improved embodiment, the controlling part 10 may be configured without working as the second magnification ratio adjusting part 14 and simplified so that the magnification ratio is not changed until the detected coordinates are varied after the magnifying and displaying process is started. That is, steps S25-S30 may be omitted and, when the magnifying and displaying part 12 decides at step S24 that the detected coordinates are not varied (step S24: NO), process may be returned to step S23.

In a third improved embodiment, the controlling part 10 may be configured without working as the first magnification ratio adjusting part 13 and simplified so that the magnification ratio is not changed when the space movement amount is varied during the magnifying and displaying process is executed. That is, step S32 may be omitted and the predetermined magnification ratio stored in the nonvolatile memory in advance may be used at step S33.

In a fourth improved embodiment, the magnifying and displaying part 12 may finish the magnifying and displaying process when the detected coordinates are varied during the magnifying and displaying process is executed. That is, steps S31-S37 may be omitted and, when the magnifying and displaying part 12 decides at step S24 and step S29 that the detected coordinates are varied (step S24: YES, step S29: Yes), the magnifying and displaying process may be finished.

Although, in the above-described embodiment, an example of setting the second threshold Z2 larger than zero is illustrated in FIG. 3, in a fifth improved embodiment, the second threshold Z2 may be set by zero. That is, in such a case, by coming the indication body D into contact with the display area P, the user can make the instruction receiving part 11 receive the instruction corresponding to the image displayed at the position with which the indication body D comes into contact.

While the present disclosure has been described with reference to the preferable embodiment of the image forming apparatus of the disclosure and the description has technical preferable illustration, the disclosure is not to be restricted by the embodiment and illustration. Components in the embodiment of the present disclosure may be suitably changed or modified, or variously combined with other components. The claims are not restricted by the description of the embodiment.

What is claimed is:

1. A display controlling device, comprising:
a display part having a display area on which a plurality of images are displayed;
a distance detecting part detecting a space distance between an indication body and the display area, the indication body being used for indicating the image displayed on the display area by a user;
a coordinate detecting part detecting coordinates on the display area corresponding to a position of the indication body when the space distance detected by the distance detecting part is equal or less than a predetermined first threshold value; and
a magnifying and displaying part, when detected coordinates detected by the coordinate detecting part are not varied for a predetermined limit time or more, executing magnifying and displaying process magnifying a periphery image displayed on a periphery area with predetermined dimensions including the detected coordinates on the display area by a predetermined magnification ratio to create a periphery magnification image and displaying the periphery magnification image with superimposing the periphery magnification image on the periphery image.

2. The display controlling device according to claim 1, wherein
the magnifying and displaying part, when the detected coordinates detected are varied during the magnifying and displaying process is executed, moves and displays the periphery magnification image so as to follow to variation of the detected coordinates.

3. The display controlling device according to claim 1 further comprising:
a first magnification ratio adjusting part making the magnification ratio large as a space movement amount becomes small, the space movement amount being taken by subtracting the space distance, that is detected by the distance detecting part when the execution of the magnifying and displaying process is started, from the space distance, that is detected by the distance detecting part, during the magnifying and displaying process is executed.

4. The display controlling device according to claim 1 further comprising:
a second magnification ratio adjusting part making the magnification ratio large as an elapsed time from a start time of the magnifying and displaying process is prolonged until the detected coordinates are varied after the magnifying and displaying process is started.

5. The display controlling device according to claim 1, wherein
the display part displays an image, in which a plurality of alternative images are arranged for choosing with the indication body by the user, onto the display area.

6. An electronic apparatus comprising:
a display controlling device including
a display part having a display area on which a plurality of images are displayed,
a distance detecting part detecting a space distance between an indication body and the display area, the indication body being used for indicating the image displayed on the display area by a user,
a coordinate detecting part detecting coordinates on the display area corresponding to a position of the indication body when the space distance detected by the distance detecting part is equal or less than a predetermined first threshold value, and
a magnifying and displaying part, when detected coordinates detected by the coordinate detecting part are not varied for a predetermined limit time or more, executing magnifying and displaying process magnifying a periphery image displayed on a periphery area with predetermined dimensions including the detected coordinates on the display area by a predetermined magnification ratio to create a periphery magnification image and displaying the periphery magnification image with superimposing the periphery magnification image on the periphery image; and
an instruction receiving part, when the space distance detected by the distance detecting part becomes equal or less than a second threshold value smaller than the first threshold value, receiving an instruction corresponding to the image displayed with include the detected coordinates on the display area.

7. The electronic apparatus according to claim 6, wherein
the magnifying and displaying part, when the detected coordinates detected are varied during the magnifying and displaying process is executed, moves and displays the periphery magnification image so as to follow to variation of the detected coordinates.

8. The electronic apparatus according to claim 6, wherein
the display controlling device further includes
a first magnification ratio adjusting part making the magnification ratio large as a space movement amount becomes small, the space movement amount being taken by subtracting the space distance, that is detected by the distance detecting part when the execution of the magnifying and displaying process is started, from the space distance, that is detected by the distance detecting part, during the magnifying and displaying process is executed.

9. The electronic apparatus according to claim 6, wherein
the display controlling device further includes
a second magnification ratio adjusting part making the magnification ratio large as an elapsed time from a start time of the magnifying and displaying process is prolonged until the detected coordinates are varied after the magnifying and displaying process is started.

10. The electronic apparatus according to claim 6, wherein
the display part displays an image, in which a plurality of alternative images are arranged for choosing with the indication body by the user, onto the display area.
